(19) United States
(12) Patent Application Publication
(10) Pub. No.: US 2011/0107142 A1
(43) Pub. Date: May 5, 2011

(54) ULTRASONIC DIAGNOSTIC METHOD AND SYSTEM FOR SUPPORTING SELF DIAGNOSIS AND RESTORATION FUNCTION

(76) Inventors: Beom Gyu KIM, Goyang Si (KR); Jungsoo KIM, Seoul (KR)

(21) Appl. No.: 12/886,249

(22) Filed: Sep. 20, 2010

(30) Foreign Application Priority Data
Nov. 4, 2009 (KR) 10-2009-0105820

(51) Int. Cl. G06F 11/14

(52) U.S. Cl. 714/15; 714/E11.117

(57) ABSTRACT

An ultrasonic diagnostic method and system are provided. The ultrasonic diagnostic method includes performing booting of a system using a kernel, after a Basic Input/Output System (BIOS) is executed and an error is not recorded in a memory; recording an error in the memory when the error occurs in executing an ultrasonic diagnostic program; transmitting the recorded error to a server via a network; and receiving, from the server, a recovery file used to restore the ultrasonic diagnostic program, and restoring the ultrasonic diagnostic program using the received recovery file.

### CROSS-REFERENCE TO RELATED APPLICATION

This application claims the benefit of Korean Patent Application No. 10-2009-0105820, filed on Nov. 4, 2009, in the Korean Intellectual Property Office, the disclosure of which is incorporated herein by reference.

### BACKGROUND 1. Field of the Invention

The present invention relates to an ultrasonic diagnostic method and system, and more particularly, to an ultrasonic diagnostic method and system that may easily restore an ultrasonic diagnostic program when an error occurs while executing the ultrasonic diagnostic program.

2. Description of the Related Art

An ultrasonic diagnostic system enables a user to observe an object with the naked eye without damaging an internal portion of the object, and may be employed in diagnosis of disease. Conventional ultrasonic diagnostic systems may experience malfunctions, requiring a service engineer to directly inspect the system to determine the cause of the malfunction and restore normal operations. When such systems are deployed in a hospital or clinical setting, such field visits may become costly and reduce system availability.

As ultrasound technology develops, such systems have become more complicated and the cause of such malfunctions becomes more difficult to ascertain.

Therefore, there is a demand for an ultrasonic diagnostic system that may transmit an error to a server upon occurrence of the error and may open a recovery file received from the server, to quickly restore an ultrasonic diagnostic program using the recovery file.

### SUMMARY

An aspect of the present invention provides an ultrasonic diagnostic method and system in which, when an execution error is detected while executing an ultrasonic diagnostic program, a recovery file used to restore the ultrasonic diagnostic program may be received from a server associated with a system where the ultrasonic diagnostic program is launched, and the received recovery file may be opened, so that the ultrasonic diagnostic program may be quickly restored.

According to an aspect of the present invention, there is provided an ultrasonic diagnostic method including performing booting of a system using a kernel, after a Basic Input/Output System (BIOS) is executed and an error is not recorded in a memory; recording an error in the memory when the error occurs in executing an ultrasonic diagnostic program; transmitting the recorded error to a server via a network; and receiving, from the server, a recovery file used to restore the ultrasonic diagnostic program and restoring the ultrasonic diagnostic program using the received recovery file.

According to another aspect of the present invention, there is provided an ultrasonic diagnostic method including storing a detected execution error in a memory when the execution error is detected while executing an ultrasonic diagnostic program; changing a scheme for booting of a system based on the detected execution error, the ultrasonic diagnostic program being launched in the system; and receiving a recovery file from a server and opening the received recovery file to restore the ultrasonic diagnostic program.

The changing may include performing rebooting of the system using a startup application (e.g., Splashtop™ (DeviceVM; San Jose, Calif.)) within a predetermined time n to change the scheme for booting the system, n being a positive integer.

According to another aspect of the present invention, there is provided an ultrasonic diagnostic system including an error detector to detect an execution error, the execution error occurring while executing an ultrasonic diagnostic program; a boot changing unit to change a scheme for booting a system based on the detected execution error, the ultrasonic diagnostic program being launched in the system; and a recovery unit to receive a recovery file from a server and to open the received recovery file, to restore the ultrasonic diagnostic program.

According to embodiments of the present invention, when an execution error is detected while executing an ultrasonic diagnostic program, the detected execution error may be transmitted to a server which is associated with a system where the ultrasonic diagnostic program is launched. Therefore, it is possible to precisely determine the error occurring in the system based on information concerning the execution error transmitted to the server, without a need for a service engineer to directly visit the site where the execution error occurs.

Also, according to embodiments of the present invention, a scheme for booting a system where an ultrasonic diagnostic program is launched may be changed based on an execution error detected while executing the ultrasonic diagnostic program, and a recovery file may be received from a server which is associated with the system to which the changed scheme is applied and may be opened to restore the ultrasonic diagnostic program. Thus, it is possible to quickly restore the ultrasonic diagnostic program.

Hence, it is possible to reduce economic losses due to malfunctions of the ultrasonic diagnostic system and an onsite response service by a service engineer.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a relationship between an ultrasonic diagnostic system and a server according to an embodiment of the present invention;

FIG. 2 is a block diagram illustrating a configuration of an ultrasonic diagnostic system according to an embodiment of the present invention;

FIG. 3 is a flowchart illustrating an ultrasonic diagnostic method according to an embodiment of the present invention;

FIG. 4 is a block diagram illustrating a configuration of an ultrasonic diagnostic system according to another embodiment of the present invention; and

FIG. 5 is a flowchart illustrating an ultrasonic diagnostic method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

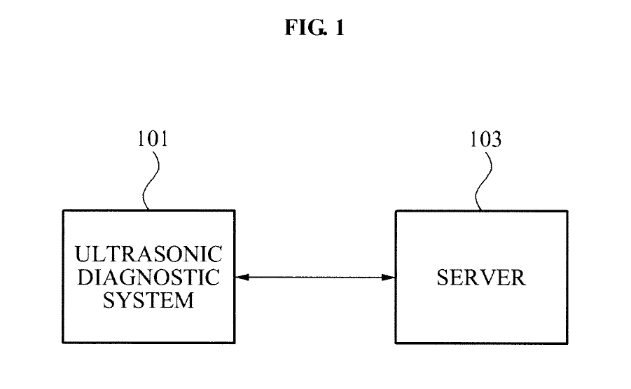

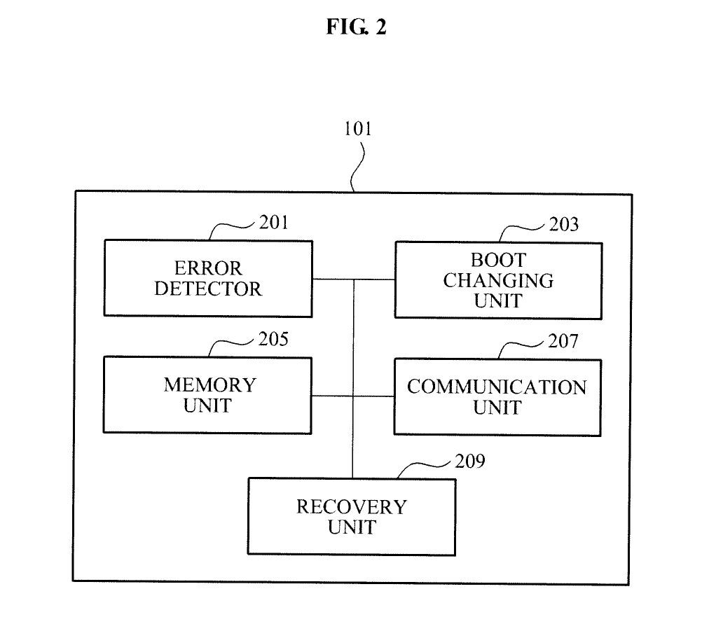

FIG. 1 is a block diagram illustrating a relationship between an ultrasonic diagnostic system 101 and a server 103 according to an embodiment of the present invention. FIG. 2 is a block diagram illustrating a configuration of the ultrasonic diagnostic system 101 according to an embodiment of the present invention.

Referring to FIGS. 1 and 2, the ultrasonic diagnostic system 101 may include an error detector 201, a boot changing unit 203, a memory unit 205, a communication unit 207 and a recovery unit 209.

The error detector 201 may detect an execution error and perform a self diagnosis of a state of the ultrasonic diagnostic system 101, when the execution error occurs while executing an ultrasonic diagnostic program.

The boot changing unit 203 may change a scheme for booting a system where the ultrasonic diagnostic program is launched, based on the detected execution error, so that booting of the system may be performed using a different scheme for booting. Herein, the system where the ultrasonic diagnostic program is launched may be the ultrasonic diagnostic system 101.

Specifically, the boot changing unit 203 may perform initial booting of the ultrasonic diagnostic system 101 using a kernel. After the execution error is detected, the boot changing unit 203 may perform rebooting of the ultrasonic diagnostic system 101 using a startup application within a predetermined time n. Here, n is a positive integer, and the startup application refers to an Operating System (OS), such as (e.g., Splashtop™ (DeviceVM; San Jose, Calif.) based on Linux, to reduce a boot-up time. In other words, the startup application may be used to perform booting of a system more quickly, i.e., within several seconds.

Alternatively, after the execution error is detected, the boot changing unit 203 may command the ultrasonic diagnostic system 101 to display a message prompting a user to select whether to use the kernel or the startup application to boot the ultrasonic diagnostic system 101, and may perform booting of the ultrasonic diagnostic system 101 according to a user's selection.

The boot changing unit 203 may record the detected execution error in the memory unit 205, and the detected execution error may be recorded in the memory unit 205 prior to booting the ultrasonic diagnostic system 101.

Herein, the execution error occurring while executing the ultrasonic diagnostic program may include information regarding the time at which the execution error occurs, the portion where the execution error occurs, and the contents of the execution error.

Also, the boot changing unit 203 may record a user file together with the execution error in the memory file 205, to backup the user file to the memory unit 205.

The memory unit 205 may store the detected execution error or the user file. Here, the memory unit 205 may be implemented by a Non-Volatile Random Access Memory (NVRAM). The NVRAM may preserve currently processed data even when a system is powered off.

The communication unit 207 may transmit at least one of the execution error, the user file, and configuration information to the server 103 via a wired or wireless Internet network. Here, the configuration information may be related to at least one of the ultrasonic diagnostic program and the ultrasonic diagnostic system 101.

Specifically, the communication unit 207 may transmit the execution error recorded in the memory unit 205 to the server 103, which is associated with the ultrasonic diagnostic system 101. In this instance, after the booting of the ultrasonic diagnostic system 101 is performed and the scheme for booting the system is changed, the communication unit 207 may transmit the execution error to the server 103. Also, the communication unit 207 may transmit only the last execution error among execution errors, based on times at which the execution errors occur.

While transmitting the execution error, the communication unit 207 may also transmit the configuration information to the server 103. The configuration information may include, for example, at least one of a program version, a main function supported by a program, a number of execution errors, a frequency of occurrence of execution errors, user identification information, management information, a manufacturing date of the ultrasonic diagnostic system 101, and a location where the ultrasonic diagnostic system 101 is installed.

Also, the communication unit 207 may transmit the user file contained in the ultrasonic diagnostic system 101 to the server 103, to backup the user file to the server 103.

The recovery unit 209 may receive a recovery file from the server 103, and may open the received recovery file, to restore the ultrasonic diagnostic program using the recovery file. Here, the recovery file may be standardized, and may be an image file capable of restoring the ultrasonic diagnostic program, but is not limited thereto. Accordingly, the recovery file may be an image file capable of eliminating the detected execution error.

Also, the recovery unit 209 may load the user file recorded in the memory unit 205, or may keep the original user file where the execution error has not occurred, using the user file received from the server 103.

As described above, when the execution error is detected while executing the ultrasonic diagnostic program, the detected execution error may be transmitted to the server which is associated with the ultrasonic diagnostic system where the ultrasonic diagnostic program is launched. Thus, it is possible to precisely determine the error occurring in the system based on information concerning the execution error transmitted to the server, without a need for a service engineer to directly visit the site where the execution error occurs.

Also, the ultrasonic diagnostic system may change a scheme for booting a system where an ultrasonic diagnostic program is launched, based on an execution error detected while executing the ultrasonic diagnostic program, and may open a recovery file received from the server, and thus it is possible to quickly restore the ultrasonic diagnostic program.

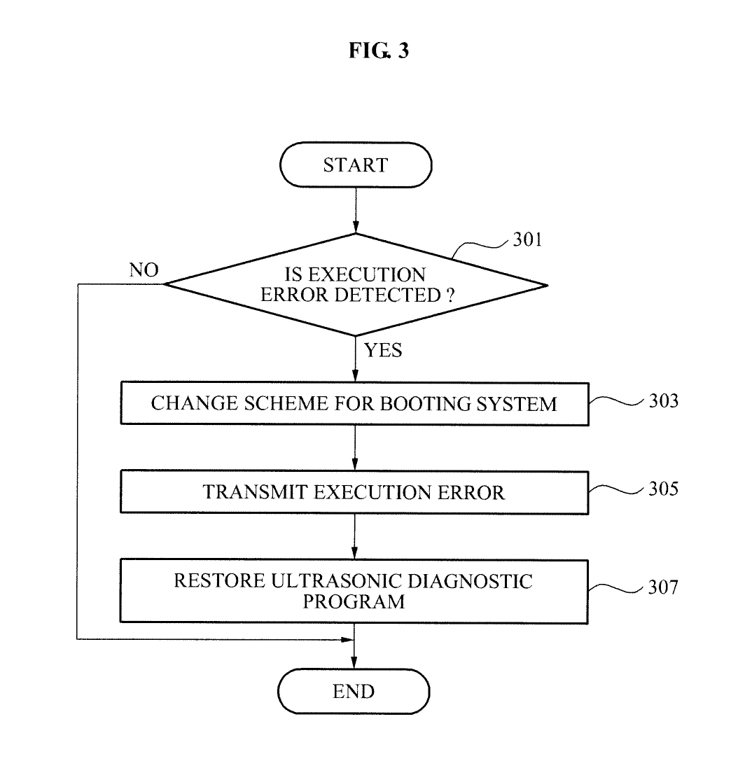

FIG. 3 is a flowchart illustrating an ultrasonic diagnostic method according to an embodiment of the present invention. Here, it is assumed that initial booting of an ultrasonic diagnostic system according to the embodiment of the present invention is performed using a kernel, and that an ultrasonic diagnostic program is normally driven in the ultrasonic diagnostic system.

Referring to FIG. 3, the ultrasonic diagnostic system may detect an execution error occurring while executing the ultrasonic diagnostic program, in operation 301.

In operation 301, when the execution error occurs, the ultrasonic diagnostic system may detect the execution error and may perform a self diagnosis of the state thereof.

Subsequently, the ultrasonic diagnostic system may record the detected execution error in a built-in memory unit. Specifically, after a scheme for booting the ultrasonic diagnostic system is changed, the detected execution error may be recorded in the memory unit. Also, the ultrasonic diagnostic system may record a user file together with the execution error in the memory unit, to backup the user file to the memory unit.

Here, the memory unit may be implemented by an NVRAM, which is capable of preserving currently processed data even when a system is powered off.

Also, the ultrasonic diagnostic system may transmit the user file to the server associated therewith, to backup the user file to the server.

In operation 303, the ultrasonic diagnostic system may change the scheme for booting, based on the detected execution error.

Specifically, initial booting of the ultrasonic diagnostic system may be performed using a kernel. After the execution error is detected, rebooting of the ultrasonic diagnostic system may be performed using a startup application within a predetermined time n. Here, n is a positive integer, and the startup application refers to an OS, such as (e.g., Splashtop™ (DeviceVM; San Jose, Calif.)) based on Linux, to reduce a boot-up time. In other words, the startup application may be used to perform booting of a system more quickly, i.e., within several seconds.

Accordingly, the ultrasonic diagnostic system may be quickly booted using the startup application, to thereby reduce a time required to restore the ultrasonic diagnostic program.

Alternatively, after the execution error is detected, the ultrasonic diagnostic system may control a display of a message prompting a user to select whether to use the kernel or startup application to perform booting, so that rebooting of the ultrasonic diagnostic system may be performed according to a user's selection.

In operation 305, the ultrasonic diagnostic system may transmit the execution error recorded in the memory unit to the server associated therewith.

While transmitting the execution error, the ultrasonic diagnostic system may also transmit at least one of the user file and configuration information to the server 103. Here, the configuration information may be related to at least one of the ultrasonic diagnostic program and the ultrasonic diagnostic system.

The configuration information may include, for example, at least one of a program version, a main function supported by a program, a number of execution errors, a frequency of occurrence of execution errors, user identification information, management information, a manufacturing date of the ultrasonic diagnostic system, and a location where the ultrasonic diagnostic system is installed.

In operation 307, the ultrasonic diagnostic system may restore the ultrasonic diagnostic program.

Specifically, the ultrasonic diagnostic system may receive a recovery file from the server and open the received recovery file, to restore the ultrasonic diagnostic program.

Also, the ultrasonic diagnostic system may load the user file recorded in the memory unit, or may keep the original user file where the execution error has not occurred, using the user file received from the server.

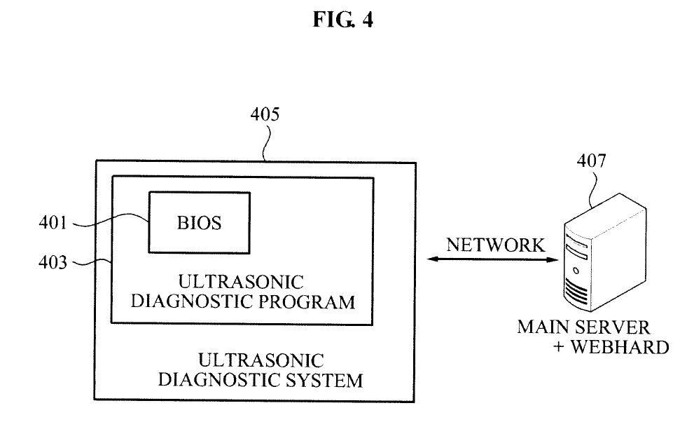

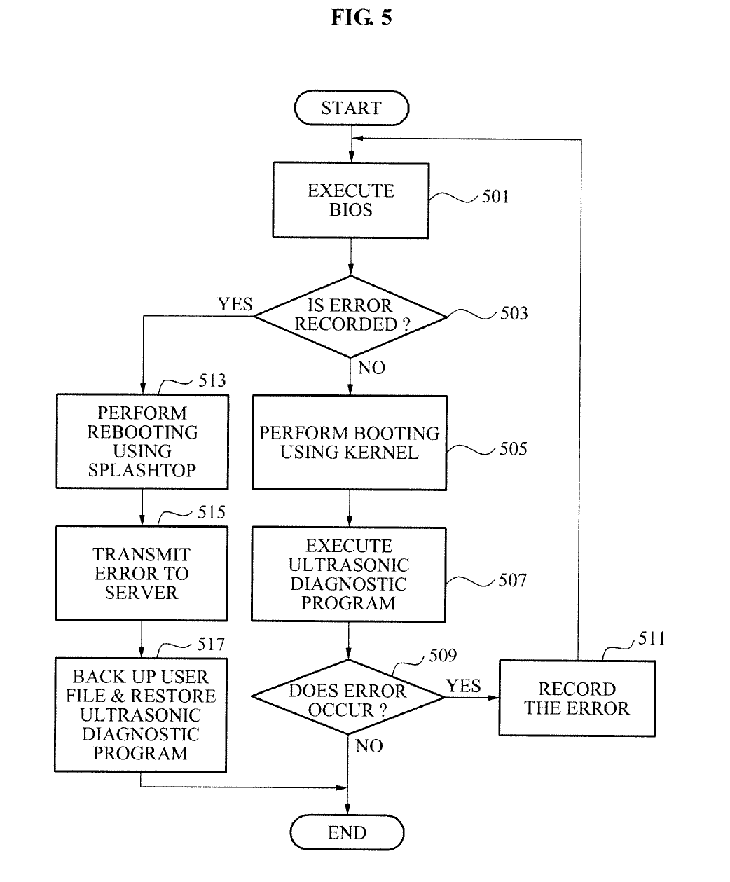

FIG. 4 is a block diagram illustrating a configuration of an ultrasonic diagnostic system 405 according to another embodiment of the present invention. FIG. 5 is a flowchart illustrating an ultrasonic diagnostic method according to another embodiment of the present invention.

Referring to FIGS. 4 and 5, the ultrasonic diagnostic system 405 may execute a Basic Input/Output System (BIOS) 401 in operation 501. When no error is recorded in a memory (not shown) in operation 503, booting of the ultrasonic diagnostic system 405 may be performed using a kernel in operation 505.

In operation 507, the ultrasonic diagnostic system 405 may execute an ultrasonic diagnostic program 403.

In operation 509, when an error occurs while executing the ultrasonic diagnostic program 403, the ultrasonic diagnostic system 405 may record the error in the memory in operation 511.

When an error is recorded in the memory in operation 503, rebooting of the ultrasonic diagnostic system 405 may be performed using a startup application in operation 513.

The rebooting of the ultrasonic diagnostic system 405 may be performed using the startup application within a predetermined time n. Here, n is a positive integer.

While the startup application is used to perform rebooting of the ultrasonic diagnostic system 405 in operation 513, there is no limitation thereto. Alternatively, a message prompting a user to select whether to use the kernel or the startup application to boot the ultrasonic diagnostic system 405 may be displayed, so that rebooting of the ultrasonic diagnostic system 405 may be performed according to a user's selection.

In operation 515, the ultrasonic diagnostic system 405 may transmit the error recorded in the memory to a server 407 via a network.

In this instance, the ultrasonic diagnostic system 405 may transmit the last error to the server 407, based on times at which errors occur.

Also, the ultrasonic diagnostic system 405 may transmit information regarding a version of software and hardware to the server 407.

In operation 517, the ultrasonic diagnostic system 405 may backup a user file to the server 407, may receive a recovery file for the ultrasonic diagnostic program from the server 407, and may then restore the ultrasonic diagnostic program.

As described above, in the ultrasonic diagnostic method according to the embodiments of the present invention, when an execution error is detected while executing an ultrasonic diagnostic program, the detected execution error may be transmitted to a server which is associated with a system where the ultrasonic diagnostic program is launched. Therefore, it is possible to precisely determine the error occurring in the system based on information concerning the execution error transmitted to the server, without a need for a service engineer to directly visit the site where the execution error occurs.

Also, in the ultrasonic diagnostic method according to the embodiments of the present invention, a scheme for booting a system where an ultrasonic diagnostic program is launched may be changed based on an execution error detected while executing the ultrasonic diagnostic program, and a recovery file received from a server may be opened. Thus, the ultrasonic diagnostic program may be restored relatively quickly.

Hence, it is possible to reduce economic losses due to malfunctions of the ultrasonic diagnostic system and an onsite response service by a service engineer.

The above-described embodiments of the present invention may be recorded in computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), RAM, flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An ultrasonic diagnostic method comprising:
booting a system using a kernel, after a Basic Input/Output System (BIOS) is executed and an error is not recorded in a memory;
recording an error in the memory when the error occurs in executing an ultrasonic diagnostic program;
transmitting the recorded error to a server via a network; and
receiving, from the server, a recovery file used to restore the ultrasonic diagnostic program, and restoring the ultrasonic diagnostic program using the received recovery file.

2. The ultrasonic diagnostic method of claim 1, further comprising rebooting the system using a startup application within a predetermined time n when the error is recorded in the memory, n being a positive integer.

3. An ultrasonic diagnostic method comprising:
storing a detected execution error in a memory when the execution error is detected while executing an ultrasonic diagnostic program;
changing a scheme for booting of a system based on the detected execution error, the ultrasonic diagnostic program being launched in the system; and
receiving a recovery file from a server and opening the received recovery file to restore the ultrasonic diagnostic program.

4. The ultrasonic diagnostic method of claim 3, wherein the changing comprises performing rebooting of the system using the startup application within a predetermined time n to change the scheme for booting the system, n being a positive integer.

5. The ultrasonic diagnostic method of claim 3, further comprising transmitting the execution error stored in the memory to the server.

6. An ultrasonic diagnostic system comprising:
an error detector configured to detect an execution error, the execution error occurring while executing an ultrasonic diagnostic program;
a boot changing unit configured to change a scheme for booting a system based on the detected execution error, the ultrasonic diagnostic program being launched in the system; and
a recovery unit configured to receive a recovery file from a server and to open the received recovery file, to restore the ultrasonic diagnostic program.

7. The ultrasonic diagnostic system of claim 6, wherein the boot changing unit is configured to reboot the system using a startup application within a predetermined time n to change the scheme for booting the system, n being a positive integer.

8. The ultrasonic diagnostic system of claim 6, further comprising:
a memory unit configured to store the detected execution error; and
a communication unit configured to transmit the execution error stored in the memory unit to the server.

9. The ultrasonic diagnostic system of claim 6, further comprising:
a communication unit configured to transmit configuration information to the server, the configuration information being related to at least one of the system and the ultrasonic diagnostic program.

10. The ultrasonic diagnostic system of claim 6, further comprising:
a communication unit configured to transmit a user file to the server, the user file being contained in the system.
